(19) United States
(12) Patent Application Publication
(10) Pub. No.: US 2019/0297319 A1
(43) Pub. Date: Sep. 26, 2019

(54) Individual visual immersion device for a moving person

(71) Applicant: STEREOLABS, MONTROUGE (FR)

(72) Inventors: Cécile SCHMOLLGRUBER, MONTROUGE (FR); Edwin AZZAM, MONTROUGE (FR); Olivier BRAUN, MONTROUGE (FR)

(21) Appl. No.: 16/306,545

(22) PCT Filed: Jun. 9, 2017
(86) PCT No.: PCT/FR2017/000116

§ 371 Date: Nov. 30, 2018

(30) Foreign Application Priority Data
Jun. 10, 2016 (FR) 10 55 388

(51) Int. Cl. H04N 13/344; G06T 19/00; H04N 13/207; H04N 13/271; H04N 13/366

(52) U.S. Cl. CPC H04N 13/344; G06T 19/006; G06T 2200/04; H04N 13/271; H04N 13/366; H04N 13/207

(57) ABSTRACT

Individual visual immersion device for a moving person, comprising a means for placing the device on the person and a means for displaying immersive images in front of the eyes of the person, characterised in that it further comprises a stereoscopic image sensor (A) for generating two synchronised image streams of a same scene taken at two distinct angles, a means for calculating a piece of information on the disparity between the images of pairs of synchronised images of the two streams (B, F1, F2), a means for calculating current movement characteristics of the device (C) from the piece of disparity information, and means for composing a stream of immersive images (D, E, H) that arc coherent with the movement characteristics.

### TECHNOLOGICAL FIELD AND BACKGROUND

The disclosure relates to an augmented or virtual reality helmet intended to be worn by a user and comprising a rectangular screen on which synchronized images are broadcast on the left half and the right half, an optical system making it possible to view, correctly with the left eye and the right eye, respectively, the images broadcast on the left and the right of the screen, each eye needing to see the image and therefore the corresponding part of the screen. It is also possible to use two synchronized screens that each display the corresponding left or right image, rather than a single screen.

The helmet integrates a stereoscopic camera (made up of two centralized sensors) reproducing the user's eyes and oriented toward the scene that the user could see if his eyes were not hidden by the helmet.

This camera is connected to a computing unit inside or outside the helmet allowing the processing of the images coming from the two sensors.

The associated image processing is the algorithm succession making it possible first to extract the depth map of the scene, then to use this result with the associated left and right images coming from the stereoscopy to deduce the change of position and orientation of the camera therefrom between the time t-e and the time t where e is the duration of an image of the camera (inverse of the image frequency).

These different results can be used to display the actual scene seen by the camera as if the user was seeing this scene directly, or to display a virtual model on the screen and to modify the virtual point of view by combining it with the position and the orientation of the camera in space, or to combine these two results by coherently incorporating an image stream or virtual objects in the actual scene.

The issue of incorporating virtual elements into a real image stream has already been addressed in document WO2015123775A1, which relates to the integration of a stereoscopic camera into a virtual reality helmet also comprising associated methods for capturing, processing and displaying the elements optimally, in particular managing occlusions of the virtual objects by real objects.

However, no estimate of the position and orientation of the camera in space is described aside from obtaining the position of the helmet based on at least one known marker needing to be visible at all times by at least one camera.

If no method for estimating the position and orientation of the camera is carried out, or if the marker is incorrectly identified or lost from sight, a movement of the user's head is not described and the virtual elements remain in the same place in the image, which makes their integration inconsistent.

Another means of the state of the art commonly used in particular in mobile telephones is the use of an inertial measurement unit (IMU). The problem of this technology is that it only makes it possible to detect the orientation of the system and much less its movement in space, which is quickly lost.

In the first case, the major drawback of the method is the need to place the elements outside the helmet to determine the position and the precise orientation of the system.

In the second case, the drawback is obviously the lack of information on the position of the user in time. This limits the use of a helmet integrating this type of measurement to a use of the tripod type, without possible movement of the user.

### BRIEF SUMMARY

In this context, proposed is an individual visual immersion device for a moving person, comprising a means for placing the device on the person and a means for displaying immersive images in front of the eyes of the person, characterized in that it further comprises a stereoscopic image sensor for generating two synchronized image streams of a same scene taken at two distinct angles, a means for calculating a piece of information on the disparity between the images of pairs of synchronized images of the two streams, a means for calculating current movement characteristics of the device from the piece of disparity information, and means for composing a stream of immersive images that are coherent with the movement characteristics.

The disclosure proposes the following improvement: using a single and same system, in the case at hand a stereoscopic camera, to obtain two stereoscopic images, the depth map associated with the left image and the position estimate of the camera fixed on the helmet.

The combination of these results makes it possible, in a virtual reality operating mode, to view a virtual world by relaying the movements of the helmet (rotation and translation) onto the virtual camera used to render this world according to the point of view of the user, while using the depth map to detect an interaction with the outside world (object close to the user in his line of sight, interaction with a movement in the real world seen by the camera but invisible by the user).

It also makes it possible, in an augmented reality operating mode, to display two images, each visible by one of the eyes of the user (so that the user can reconstruct a human-type vision of his environment), to incorporate virtual objects into this real view coherently. It is therefore appropriate, in the same way as in operating mode (A), to use the position and the orientation of the “real” camera in order to orient the virtual objects seen by a virtual camera in the same way as the real world so that the placement of the virtual objects remains consistent with the real world. Furthermore, the virtual objects being displayed superimposed on the real image, it is necessary, in order to position a virtual object behind a real object, to conceal part of the virtual object to give the impression that it is behind the real object. In order to hide the part of a virtual object, it is necessary to use the depth map from the camera in order to compare, pixel by pixel, the position of the virtual object with the real world.

In order to increase the reliability of the results, it is optionally considered to use an inertial measurement unit in order to compare the rotations from said unit and the rotations from the calculation based on the images of the camera and its depth map.

In summary, the following optional features may be present:
the means for computing characteristics of the movement also uses at least one of the image streams;
the composition means create immersive augmented reality images by using the images from the sensor and the disparity information to choose the elements of the scene to conceal with virtual elements;
the composition means create immersive virtual reality images;
an inertial measurement unit and wherein the means for computing the characteristics of the current movement of the device uses the information provided by the inertial measurement unit;
the disparity information between the synchronized images of the two streams is densified by performing a detection of contours in the images and estimating unknown disparity values as a function of the contours or by interpolating known disparity values;
the means for computing characteristics of the current movement of the device from the disparity information evaluates the movement from a reference image chosen as a function of its brightness or its sharpness, either when the position of the camera has exceeded a predefined overall movement threshold, or when it is possible to evaluate, with a precision reaching a predefined threshold, all of the components of the movement.

### BRIEF DESCRIPTION OF THE DRAWINGS

The disclosure will now be described in reference to the figures, among which

FIG. 1 is a flowchart showing the function for determining the position in one embodiment of the disclosure;

FIG. 2 shows the structure of one embodiment of the disclosure.

### DETAILED DESCRIPTION

The stereoscopic camera integrated into the helmet makes it possible to obtain two color images of the scene in a synchronized manner. A prior calibration of the stereoscopic sensor is necessary in order to modify the images according to a transformation matrix so as to render the frontal-parallel images (as if the images were coming from a stereoscopic camera with completely parallel optical axes).

It is thus possible to calculate the disparity map, then to obtain a depth map by transforming the pixel values into metric values owing to the prior calibration.

The depth map is said to be “dense”: in other words, most of the pixels have a depth value in metric, aside from the occlusions (part of the image visible by one of the cameras, but not visible by the other camera), zones not very textured or saturated, which represents a low percentage of the image, as opposed to a so-called sparse depth map, the majority of the pixels of which are not defined.

A first use of the depth map makes it possible to manage the inlay of virtual elements in the real image, for an augmented reality purpose. An object correctly integrated into a real image must be consistent with its environment. For example, a virtual object placed partially behind a real object must be partially hidden by said real object. The inlay of virtual elements necessarily being done on the real image, it is necessary to know the depth of each pixel of the real image and of the virtual image so as to be able to determine which pixel must be displayed (real image or virtual image pixel) during the composition of the final image to be displayed in the helmet. Since the comparison is done pixel by pixel, it is necessary to fill in the “holes” of the depth map. A contour detection is done and filling of the empty zones is done by using the adjacent pixels previously detected.

A virtual scene necessarily being seen by a virtual camera defined and placed by the user, the depth map of a virtual scene is implicit. By applying the same camera parameters between the virtual camera and the stereoscopic camera (provided by the prior calibration), it is then possible to compare each pixel of the real image with the virtual image and to compose the final pixel by choosing which pixel is closest to the camera. The system therefore makes it possible to manage the occlusions of the real objects on the virtual objects for better integration of the elements added to the scene.

This part is useful in the context of a use in augmented reality, where the composition of virtual elements with the real environment is necessary.

When the camera is in motion, the real point of view is modified. It appears necessary to calibrate the movement of the stereoscopic camera on the virtual camera, which sees the virtual environment so that the rendering of the virtual elements remains consistent with the movement of the real camera and therefore of the entire system, namely the helmet worn by the user. It is therefore necessary to know the movement of the helmet (rotation and translation) in the real world.

The use of an inertial measurement unit alone does not make it possible to have the translation on all three axes of the camera, but only the rotation.

To be able to estimate the three rotations and the three translations making it possible to go from the image n-1 (or n-X) to the image n, the left or right images n-1 (or n-X) and n as well as the disparity or depth map associated with the left or right image (depending on the choice of the image side) are used.

The calculation of the transformation matrix between the current image of the left (or alternatively) camera (t) and the preceding image of the left (or right) camera (t-1) using (left or right) monoscopic images and the associated depth map. It is optionally possible to use the rotations of the inertial measurement unit and/or the preceding results by estimating what the new position of the camera could be.

The position of the camera is estimated through a calculation of the transformation matrix, and a selection of the images n and n-1 (or n-X).

The transformation matrix between two moments is obtained by calculating the transformation between the images taken between two moments n and n-1 (or n-X).

To that end, an algorithm for detecting points of interest can be used to detect specific points (pixels) in the image n-1 (n-X). It is for example possible to use an algorithm of the Harris or Surf type, or simply to use points from the calculation of the depth map for example by applying a contour filter to select certain points of the image. It is also possible to select all of the points of the image as list of points.

The dense depth map associated with the image n-1 (n-X) is used to project the points of the image n-1 (or n-X) in 3D, then to apply the desired transformation to the cloud of points. The 3D points are next projected in the image n, and the transformation error is deduced therefrom by comparing the obtained image with the original image. The process is iterative, until obtaining the final transformation matrix between the two images. The transformation matrix comprises the rotation on the three axes rX, rY, rZ as well as the three translations tX, tY, tZ, typically taken on board in the form of a 4×4 matrix, where the rotation is a 3×3 matrix and the translation is a three-dimensional vector.

In the iteration process, several modes of operation are available on the choice of the first transformation matrix used in the iteration.

In an operating mode 1, no previous value is used and no external sensor provides any a priori on the matrix to be calculated. One therefore starts from a so-called identity matrix, where rotations and translations are nil.

In an operating mode 2, the transformation matrix is used calculated on the old pair of images and the new transformation matrix to be entered in the iterative process is predicted, using a so-called “predictive” filter. For example, it is possible to use a Kalman filter or a particular filter that uses the Monte Carlo methods to predict the following position.

In an operating mode 3, the rotation values given by the inertial measurement unit are used to create a first transformation matrix in the iterative process.

In operating mode 4, the values estimated by mode 2 and the values of the inertial unit (mode 3) are merged, in order to create a first transformation matrix in the iterative process. The merging may be a simple average, a value separation (rotation from the inertial measurement unit, translation from predictive method 2), or another form of combination (selection of the minimums).

The images n and n-1 (n-X) are selected as follows. Image n is, in each usage scenario, the current image that has just been “acquired” and processed by the correction and depth estimating module.

There are two possibilities for selecting image n-1 (n-X):
In a first case, image n-1 can be the former current image processed by the module. The depth map used is therefore the map n-1 estimated by the module for estimating the depth map.
In a second case, the notion of “keyframe” or “reference image” is introduced as image n-1. This may be an image preceding the image n-1, which we call n-X or X may vary during the use and must be below a value set by the user or left at a default value.
   The depth map used is the “saved” map associated with the image n-X.

In the first case, the value X remains constant at the value 1. One then considers that each image is a reference image.

The preferred usage mode is the second case, with reference image n-X.

The choice of the reference image in this second case can be made in different ways:
the image is chosen when the change of position of the camera exceeds a certain default value, able to be modified by the user. It is in particular estimated by this method that the movement of the camera is not due to a computing bias (“drift”).
The image is chosen when the final computing error of the transformation matrix is below a certain default value, able to be modified by the user. It is considered that the estimate of the position of the camera is good enough to be considered a “reference image”).
The image is chosen when its quality is considered sufficient in particular in terms of brightness level or low blurring by motion.

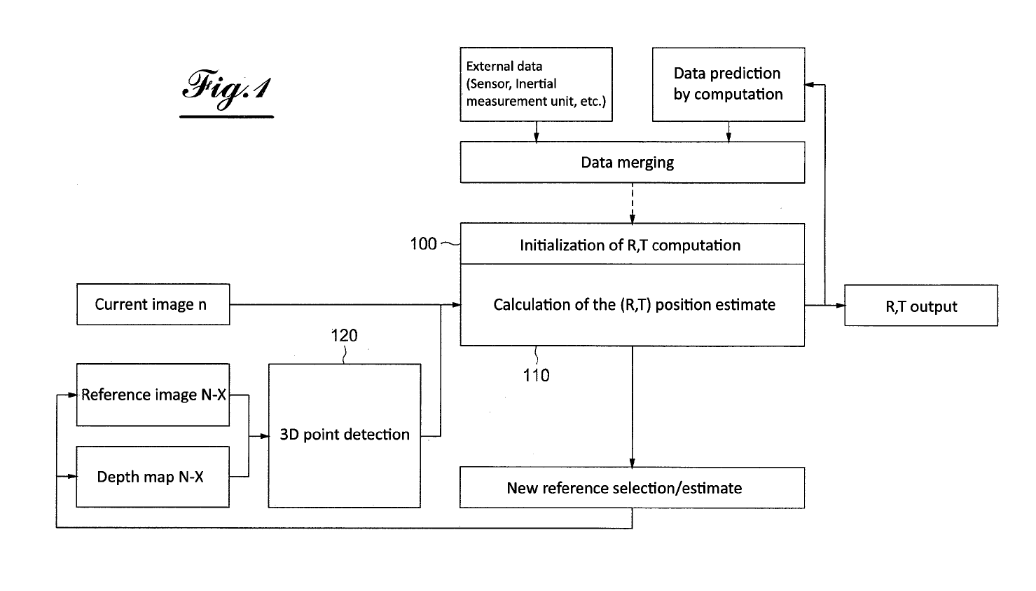

In reference to FIG. 1, one can first see the initialization 100 of the computation tracking the position R, T (for rotation and translation). This initialization is done by merging external data, coming from the sensor and an inertial movement unit, and data for tracking the position predicted based on data computed at the preceding moments.

The computation of the estimate 110 of the rotation and translation positions R and T is next conducted using the current image and the result of the detection 120 of 3D points done on the image n-X and the depth map N-X.

At the end of the computation of the estimate 110 of the position, comprehensive so-called tracking data (data estimating the rotation and translation position R,T) is provided, as well as elements for defining the initialization matrix of the position tracking computation for the following step, as well as elements for selecting a new reference N-X.

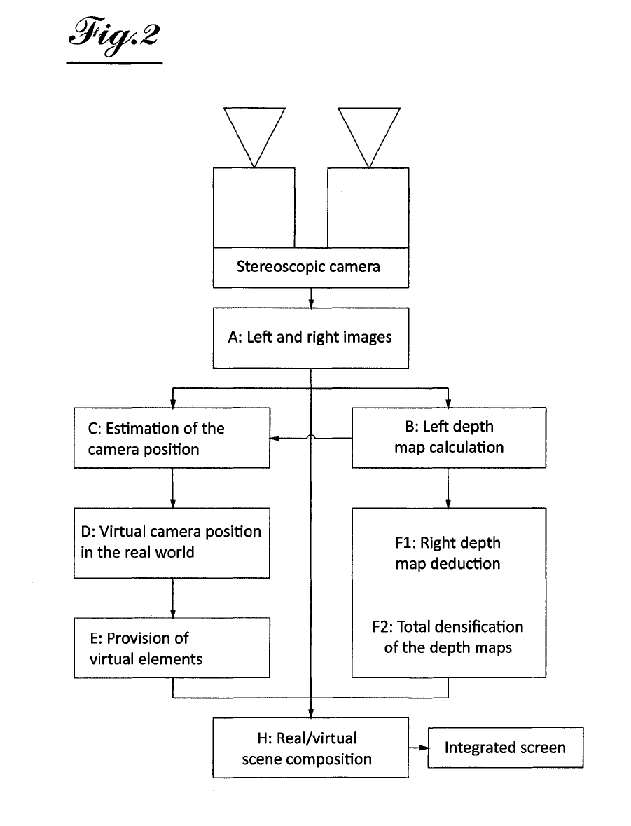

In reference to FIG. 2, we will now describe the complete architecture of the disclosure.

The right and left images are acquired simultaneously from a stereoscopic camera integrated into the virtual reality helmet, using the module A.

Module B is used to calculate the disparity map on the left image, then to calculate a metric depth map with the parameters of the stereo system. The algorithm calculates a dense disparity map.

A module C is used to calculate the transformation matrix between the current (t) and preceding (t-x) left camera using left images and the associated depth map. The transformation matrices are integrated into each image to keep the reference marks, i.e., the position of the camera upon launching the system.

A module D is used to determine the absolute position of the virtual camera in the real world. It makes it possible to make the connection between the mark in the real world and the mark in the virtual world.

The module F1/F2 in parallel with the module C uses, as input, the left disparity map from B, and from this deduces the disparity map associated with the right image in a sub-module F1. The disparity map being a match between the pixels of the right image with the pixels of the left image, it is possible, through an operation, to reverse the reference without recalculating the entire map.

The module F2 makes it possible to interpolate the missing zones of the map and to obtain a completely filled in map, with no “black” pixels. The rendering module E allows the visual rendering of the virtual elements added to the scene. This is computed with a virtual camera defined owing to the position obtained by the module D. Two images must be rendered: one for each eye. The virtual camera of the scene for the left image is identical to the position calculated by the module D, that for the right image is computed from extrinsic parameters of the system and the position matrix. Concretely, this is a translation in x corresponding to the inter-camera distance.

The module for rendering the scene H performs the integration of the virtual objects placed behind the real objects. The management of the occlusions uses the maps calculated by the module F1/F2 and the depth map implicitly calculated by the module E. The integration is thus consistent and realistic, and the user is then capable of understanding the location of the virtual object in the real world.

The two images are next sent to the screen, for the viewing by the user who is wearing the device on his head, with the screen in front of his eyes, an appropriate optic allowing a stereoscopic view.

1. An individual visual immersion device for a moving person, comprising
a means for placing the device on the person;
a means for displaying immersive images in front of eyes of the person;
a stereoscopic image sensor for generating two synchronized image streams of a same scene taken at two distinct angles;
a means for calculating a piece of information on a disparity between the images of pairs of synchronized images of the two streams;
a means for calculating current movement characteristics of the device from the piece of disparity information; and
means for composing a stream of immersive images that are coherent with the movement characteristics.

2. The individual visual immersion device according to claim 1, wherein the means for computing characteristics of the current movement of the device also uses at least one of the image streams.

3. The individual visual immersion device according to claim 1, wherein the composition means create immersive augmented reality images by using the images from the sensor and the disparity information to choose elements of the scene to conceal with virtual elements.

4. The individual visual immersion device according to claim 1, wherein the composition means create immersive virtual reality images.

5. The individual visual immersion device according to claim 1, further comprising an inertial measurement unit and wherein the means for computing the characteristics of the current movement of the device uses information provided by the inertial measurement unit.

6. The individual visual immersion device according to claim 1, wherein the disparity information between the synchronized images of the two streams is densified by performing a detection of contours in the images and estimating unknown disparity values as a function of the contours or by interpolating known disparity values.

7. The individual visual immersion device according to claim 1, wherein the means for computing characteristics of the current movement of the device from the disparity information evaluates the movement from a reference image chosen as a function of its brightness or its sharpness, either when the position of the camera has exceeded a predefined overall movement threshold, or when it is possible to evaluate, with a precision reaching a predefined threshold, all of the components of the movement.
